(19) United States
(12) Patent Application Publication
(10) Pub. No.: US 2019/0193505 A1
(43) Pub. Date: Jun. 27, 2019

(54) SYSTEM AND METHOD FOR ADJUSTING A HEIGHT OF AT LEAST ONE PART OF A UTILITY VEHICLE

(71) Applicant: KNORR-BREMSE SYSTEME FUER NUTZFAHRZEUGE GMBH, Muenchen (DE)

(72) Inventors: Levente Balogh, Szigetszentimiklos (HU); Huba Nemeth, Budapest (HU); Csaba Horvath, Biatorbagy (HU)

(21) Appl. No.: 16/329,578

(22) PCT Filed: Aug. 14, 2017
(86) PCT No.: PCT/EP2017/070612

§ 371 Date: Feb. 28, 2019

(30) Foreign Application Priority Data
Sep. 8, 2016 (DE) 10 2016 116 856.4

(51) Int. Cl. B60G 17/016

(52) U.S. Cl. CPC B60G 17/016; B60G 2300/38; B60G 2500/30; B60G 2400/824; B60G 2401/16; B60G 2300/14; B60G 2800/202; B60G 2800/203; B60G 2800/204; B60G 2800/914; B60G 2300/02; B60G 2600/71

(57) ABSTRACT

A system for adjusting a height of at least one part of a utility vehicle at at least one predetermined location, the utility vehicle having a position determination device and a height adjustment device to determine a position of the utility vehicle and to change a height of the at least one part of the utility vehicle above a ground surface, including: an interface to receive data that indicate a target height of the at least one part of the utility vehicle at the predetermined location; and a control unit that is couple-able to the position determination device and to the height adjustment device, and is configured, based on a determined position, to prompt the height adjustment device of the utility vehicle to adjust the height of the at least one part of the utility vehicle to the target height. Also described are a related utility vehicle and a method.

### FIELD OF THE INVENTION

The present invention relates to a system and a method for adjusting a height of at least one part of a utility vehicle, and in particular to a height adjustment system for self-driving vehicles.

### BACKGROUND INFORMATION

Autonomous driving is taking on increasing importance, including for utility vehicles. Although, in the autonomous control of utility vehicles, movement of the utility vehicle in a horizontal plane is of primary importance, it is likewise important to likewise autonomously control the vertical height of the utility vehicle or of at least one part of the utility vehicle. However, automatic height control is not just desirable for a self-driving vehicle, but is likewise able to improve the comfort of conventionally operated utility vehicles. Since possible misjudgments by the driver are able to be monitored at least by a control unit, it is able to be pointed out to the driver that a height adjustment at a specific point has not been carried out sufficiently.

In the conventional mode of operation of utility vehicles, the driver ultimately still retains control over the vehicle. Automatic height adjustment solutions are however extremely important for autonomously operated utility vehicles. These include for example height adjustments that are necessary in order to be able to drive the utility vehicle up particular loading ramps or to be able to take into account particular maximum heights when driving underneath bridges, or else to lower the boarding area sufficiently at bus stops. Furthermore, there are even more applications that play an important role in the utility vehicle sector.

A height adjustment in the commercial utility vehicle sector is discussed for example in U.S. Pat. No. 5,549,412 A, in which an asphalt paver is described that automatically performs height control using a sensor device in order to travel through a predetermined height profile as a function of position. A further known height adjustment system is discussed in US 2014379214 A1, in which a height level is controlled automatically when a vehicle approaches a parking position. US 2014297116 A1 discusses an adaptive suspension system that uses a vehicle position and topographical data in order to accordingly adjust the vehicle suspension device depending on the surface of the road in front and on the incline.

However, none of the systems mentioned is believed to achieve sufficient height control that functions sufficiently accurately and reliably for a self-driving utility vehicle.

There is therefore a need for alternative systems for controlling the height of utility vehicles.

### SUMMARY OF THE INVENTION

At least some of the abovementioned problems may be solved by a system and a method for adjusting a height of at least one part of a utility vehicle as described herein and a utility vehicle as described herein. The further descriptions herein define further advantageous embodiments of the subjects as described herein.

The present invention relates to a system for adjusting a height of at least one part of a utility vehicle at at least one predetermined location, wherein the utility vehicle has a position determination device and a height adjustment device that are configured to determine a position of the utility vehicle and to change a height of the at least one part of the utility vehicle above a ground surface. The system comprises an interface for receiving data that indicate a target height of the at least one part of the utility vehicle at the predetermined location; and a control unit that is able to be coupled to the position determination device and to the height adjustment device and is configured, on the basis of a determined position, to prompt the height adjustment device of the utility vehicle to adjust the height of the at least one part of the utility vehicle to the target height. The predetermined location may be for example underneath a bridge, a bus stop, a loading ramp, etc. The invention is not intended to be restricted to specific locations, or only to the extent that a position is able to be assigned to the predetermined location.

In the context of the present invention, the term “position” is intended to be understood broadly and is not intended to relate only to a globally defined position (for example within a coordinate system or determined via GPS), but is rather intended likewise to comprise relative positions that are determined for example with reference to known fixed points, such as for example buildings or markings. The relative position may be determined for example by rangefinders or other sensors. Furthermore, the “position” is not intended just to define a location in the horizontal plane, but is intended likewise to comprise vertical positions, such as for example a height above a ground surface.

The interface may be configured for example to receive the data from a remote database, in particular using a wireless connection (for example mobile radio). The interface may optionally store values for the target height together with the position of the predetermined location. To this end, it may for example access a memory of the utility vehicle, for example, or the system itself comprises a corresponding memory.

The control unit is optionally configured to perform the following functions:
to determine an instantaneous distance of the utility vehicle to the predetermined location or an expected duration until the utility vehicle reaches the predetermined location or to query this from the position determination device, and
to prompt the height adjustment device to adjust the height when the instantaneous distance or the expected duration until arrival at the predetermined location lies below a threshold value.

The control unit may optionally furthermore be configured to determine a vertical position of the at least one part of the utility vehicle on the basis of data from the position determination device or to query this from the position determination device.

The control unit may likewise be configured to determine the position in at least one horizontal coordinate on the basis of data from the position determination device or to query this from the position determination device.

The position determination device may comprise any arrangement suitable for determining positions. To this end, the arrangement may have a plurality of units, of which one unit determines for example a distance to a fixed point, another unit performs a global position determination (for example a GPS unit) and a further unit determines for example a height (for example from a ground surface) of a predetermined point of the utility vehicle. The height above a ground surface may however likewise be determined by calibrating the height adjustment device. By way of example, the height adjustment device may have a plurality of actuators that change the height of the at least one part of the utility vehicle, wherein particular actuator positions correspond to a particular height. These actuator positions may be determined beforehand through calibration of the height adjustment device.

The system therefore comprises, according to further exemplary embodiments, a sensor unit coupled to the control unit and that has at least one of the following: a radar, a laser scanner, a wireless transmission device, a mobile radio module, a differential or global positioning system, a camera and a further location system (for example a GPS module).

The control unit is optionally furthermore configured, on the basis of sensor data from the sensor unit, to acquire a reference point (for example markings on the roadway or on buildings) in surroundings of the utility vehicle and to determine a position of the utility vehicle in relation to the reference point.

The utility vehicle may optionally have at least one dynamic vehicle sensor (tachometer, rotation rate sensor, etc.) that is configured to determine a speed and/or change of direction of the utility vehicle. The control unit may then be configured, on the basis of sensor data from the at least one dynamic vehicle sensor, to determine at least one change of position in relation to a previously acquired position, so as to allow tracking of a movement path (for example a movement profile may also be recorded).

The control unit may optionally furthermore be configured to prompt the height adjustment without interaction with the driver of the utility vehicle, such that the system is able to be implemented in a self-driving utility vehicle.

The present invention also relates to a utility vehicle having a position determination device, a height adjustment device and a system as described above. The height adjustment device of the utility vehicle may be configured for example to change the height of the at least one part of the utility vehicle until a reference point or a predetermined part of the utility vehicle has reached the target height.

The at least one or predetermined part of the utility vehicle may optionally be a floor of a vehicle entrance or a characteristic highest elevation of the utility vehicle or a side point having a shortest height or a point of a vehicle axle.

The present invention also relates to a method for adjusting a height of at least one part of a utility vehicle at at least one predetermined location, wherein the utility vehicle has a position determination device and a height adjustment device that are configured to determine a position of the utility vehicle and to change a height of the at least one part of the utility vehicle above a ground surface. The method comprises the following steps:
receiving data that indicate a target height of the at least one part of the utility vehicle at the predetermined location;
determining a position of the utility vehicle; and
adjusting a height of the at least one part of the utility vehicle to the received target height.

Exemplary embodiments of the present invention therefore solve at least some of the abovementioned technical problems in that a database containing cartographic information is able to be utilized so as to obtain vertical height values and optionally store them in the utility vehicle, and to do so as a function of a horizontal position. It therefore becomes possible for particular reference points of the utility vehicle or of the vehicle combination (for example a semitrailer) to be able to be moved vertically when the horizontal position of the utility vehicle necessitates a height adjustment.

The height adjustment may be performed for example by way of a wheel suspension or a suspension system of the utility vehicle, without the driver having to interact with the system. The necessary height adjustment, as already mentioned, may be defined by way of a threshold value that defines a predetermined distance to the predetermined position or a predetermined duration that is expected to be necessary to reach the predetermined position.

The exemplary embodiments of the present invention will be better understood from the following detailed description and the attached drawings of the various exemplary embodiments, which however are not intended to be understood such that they restrict the disclosure to the specific exemplary embodiments, but rather serve merely for the purposes of explanation and understanding.

### BRIEF DESCRIPTION OF THE DRAWINGS

FIG. 1 shows an exemplary embodiment for a system for adjusting a height of at least one part of a utility vehicle at at least one predetermined location.

FIG. 2 shows exemplary situations in which the system according to exemplary embodiments is used.

FIG. 3 shows a flow diagram of a method for adjusting a height of at least one part of a utility vehicle according to one exemplary embodiment of the present invention.

### DETAILED DESCRIPTION

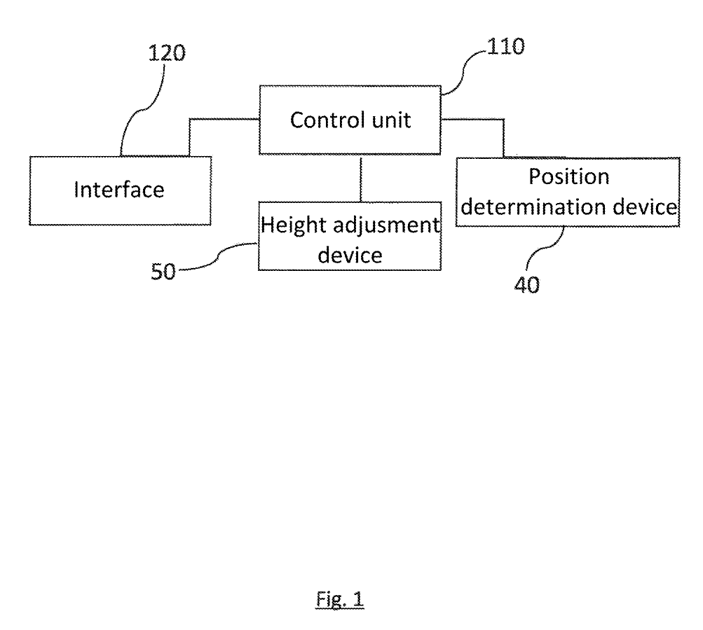

FIG. 1 shows an exemplary embodiment for a system for adjusting a height of at least one part of a utility vehicle at at least one predetermined location (position). The system comprises an interface 110 for receiving data. The data indicate a target height of the at least one part of the target vehicle at the predetermined location. The system furthermore comprises a control unit 130 that is able to be coupled to a position determination device 40 and to the height adjustment device 50. The position determination device 40 and a height adjustment device 50 are not necessarily part of the system (but may be), but rather the utility vehicle may include these devices. The position determination device 40 is configured to determine a position of the utility vehicle, and the height adjustment device 50 is configured to change a height of the at least one part of the utility vehicle above a ground surface. The control unit 130 is furthermore configured, on the basis of a determined position, to prompt the height adjustment device 50 of the utility vehicle to adjust of the height of the at least one part of the utility vehicle to the target height.

The height adjustment device 50 may for example be implemented by way of actuators that drive a wheel suspension or a suspension system of the utility vehicle, in order thus to raise or to lower a particular area of the vehicle or the entire vehicle in a defined manner.

The system, as shown in FIG. 1, uses the interface 110 of the system, by way of example, in order to obtain height information from a database. This information may be transmitted wirelessly or else in a wired manner, for example. The corresponding height information may be stored in the utility vehicle (for example in a memory, not shown in the figures) or already be stored there.

The position determination device 40 may be any desired location system, the position determination being able to be performed for example on the basis of a global positioning system (GPS), a differential global positioning system (DGPS), a camera, a radar, a lidar or other dynamic sensor signals.

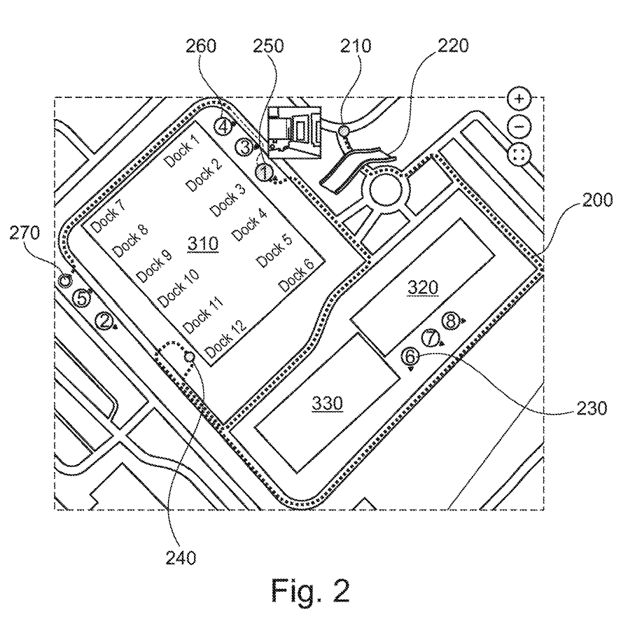

FIG. 2 shows exemplary situations in which the system according to exemplary embodiments is able to be used.

A utility vehicle may thus for example drive into an area, as shown in FIG. 2, through an entrance 210. The area contains for example three building parts, a first building 310 with a total of twelve docking stations, a second building 320 in front of which there is a bus stop 230, for example, and a third building 330.

The entrance 210 may likewise comprise a transfer station, for example, at which the driver of the utility vehicle authorizes an autonomous mode of operation for the vehicle inside the area that is shown. However, it is likewise possible for the entrance 210 to constitute just a road crossing at which automatic height correction is activated by the driver, for example. The entrance 210 may constitute a first or starting position of a path 200 that the utility vehicle follows through the area that is shown.

After the entrance 210, there is a crossing 220 (second position) that crosses the path 200. In the further course of the path, stations “6”, “7”, “8” are passed, by way of example, which may comprise a bus stop 230 (third position), for example. The course of the path 200 then leads further to a fourth position 240, and subsequently to a fifth position 250. After passing a sixth position 260, the path 200 finally leads to an exemplary parking area 270.

Height checks need to be performed along the path 200 at the predetermined positions or locations (first to seventh position).

For example, it is for instance necessary, at the crossing 220, to adjust the maximum height of the utility vehicle such that the utility vehicle is able to travel underneath the crossing 220. To this end, the wheel suspension or the suspension system may for example be changed such that the vehicle is automatically lowered, so as for example to reach a height of less than 4.10 meters, for example, in order to travel underneath the bridge (or crossing).

If the utility vehicle is a bus, it may be necessary for example to adjust the height of a passenger entrance in a floor area at the third predetermined position 230. This may be performed for example when the bus reaches the vicinity of the bus stop 230. The adjustment may bring about lowering of the floor area of the entrance, such that the floor area is situated for example 0.2 m above a ground surface.

If the utility vehicle has a lift axle, for example, it may for example be necessary, at the fourth position 240, to change the lift axle height accordingly. By way of example, at the position of the dock 12, it may be necessary to lower the lift axle using the exemplary suspension system, namely below 0.5 m, in order to achieve a connection between the wheels and the road. This may be necessary for example in order to be able to measure an axle load of the load at this point.

If the utility vehicle transports goods, it may be necessary to adjust the height of the loading platform in order for example to adjust the loading surface height to a target value at the fifth predetermined position 250. Loading or unloading at the docking station 3 is thus made possible or facilitated. By way of example, a trailer may be adjusted to an exemplary required height of 1.2 m.

At the sixth predetermined position 260, it may be necessary for example to adjust a fender height of the front fender, as a ramp may be situated at this position, for example. In order to be able to drive up such a ramp without damage, a lower section of the front fender should be raised (for example by way of the suspension system) until a minimum height of 0.4 m is reached. On the other hand, the height adjustment may be performed already when the vehicle approaches the ramp.

An exemplary parking height of the utility vehicle may be adjusted at the parking position 270.

It is understood that the predetermined locations or positions that are shown do not require actions that are predetermined in the same way by each utility vehicle. For example, a height adjustment for an entrance is typically only necessary for a bus, but not for a truck. Other height adjustments, for example a loading ramp, are likewise necessary only for particular utility vehicles. Therefore, the control unit needs to download only those data from the database that are relevant to the utility vehicle.

FIG. 2 therefore shows various possibilities of how a height adjustment of the vehicle in relation to reference points is necessary at predetermined points. For all of the actions that are shown, in particular no active involvement from the driver is necessary. Rather, the system automatically receives the height values to be complied with and the associated positions (for example coordinates of the first to seventh predetermined position) via the interface 110. When the predetermined positions are approached, the system may automatically trigger the corresponding height adjustments. This may in particular be performed immediately before arrival at the predetermined positions.

By defining a corresponding area around the predetermined positions, a frictionless process is thus able to be ensured. As already mentioned, this predetermined area may for example be a distance or optionally also comprise a time range that defines an expected arrival at the predetermined point. To trigger the height correction, threshold values may be defined that define a minimum or maximum distance from the predetermined points or else a predetermined duration. To this end, the system may continuously determine the position of the vehicle and, when a threshold value is exceeded, trigger the height adjustment of the part of the vehicle.

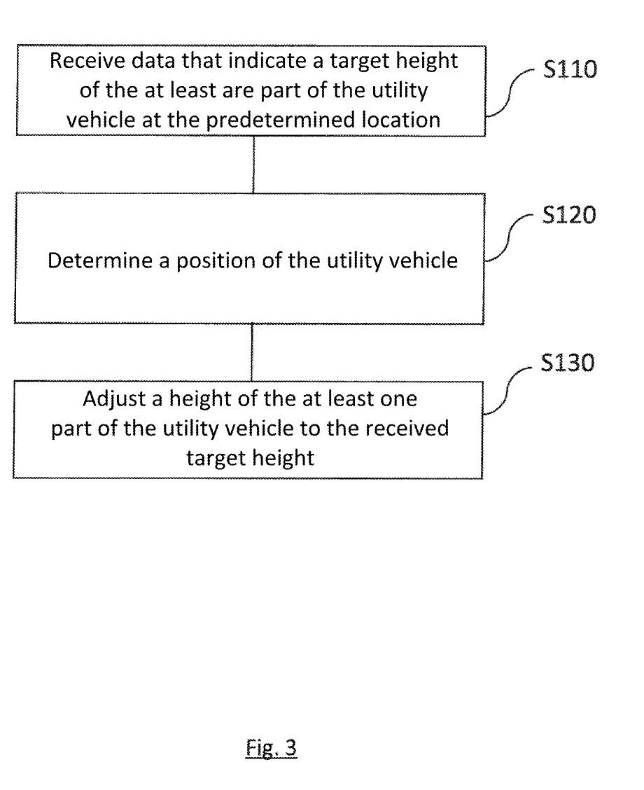

FIG. 3 shows a flow diagram for a method that is executed by the system in order to change a height of at least one part of a utility vehicle at at least one predetermined location. The utility vehicle again comprises the position determination device 40 and the height adjustment device 50, which are configured to determine a position of the utility vehicle and to change a height of the at least one part of the utility vehicle above a ground surface. The method comprises the steps: receiving S110 data that indicate a target height of the at least one part of the utility vehicle at the predetermined location, determining S120 a position of the utility vehicle, and adjusting S130 a height of the at least one part of the utility vehicle to the received target height.

It is possible for example to control the height by way of the suspension system, and this makes it possible to adjust any desired vehicle parts or else the entire vehicle in terms of height according to requirements.

Exemplary embodiments are able to be applied flexibly to any desired areas, since the accordingly relevant information is able to be loaded via the interface 110 and stored in the vehicle. The height adjustment is advantageously not performed only when the predefined positions are reached, but rather already triggered beforehand by way of corresponding threshold values, such that frictionless operation is made possible.

Exemplary embodiments allow the utility vehicle or an entire utility vehicle combination (for example a traction machine and a trailer) to be controlled directly. In this case, any desired parts of the utility vehicle, of the traction machine or of the trailer may be controlled with respect to height, such that comfort and safety are improved. The height adjustment is in particular performed automatically, and changes in surroundings are furthermore able to be detected automatically. By way of example, the distance to the predetermined points or the expected journey time may be continuously monitored and corrected so as thereby to operate the utility vehicle in a frictionless manner. To this end, a sensor unit may be integrated in the system so as for example to be able to continuously acquire the surroundings. The system may optionally access corresponding sensors of the utility vehicle. The sensors may for example a radar, a laser scanner, a wireless transmission device, a mobile radio module, a differential or global positioning system, a camera or further location systems. These sensors may be used for example to acquire the buildings 310, 320, 330 from FIG. 2 so as thereby to allow a relative position determination.

Without the present invention being restricted thereto, exemplary embodiments are able to be applied in particular for the following typical cases of application (cf. also FIG. 2)

A bus stops at a bus stop 230. In this situation, it is necessary for the suspension system to lower the entrance level at the bus stop. The required height information (for example the height of the boarding step) above the roadway may be obtained from an external database. Furthermore, the vehicle may measure this current state itself (for example using the sensor unit that is present). Furthermore, the bus may determine the distance to the bus stop, in order thus for example to be able to perform lowering immediately before stopping. It is understood that various height values may be set at various bus stops.

A transport vehicle is intended to be loaded. In this case, it is often necessary for a truck or a trailer to adjust the loading area in accordance with the circumstances at a loading station, so as to allow continuous loading and unloading without setting down at the loading area. Nowadays, such operations are normally performed manually by the driver, who first of all has to adjust the vehicle to the loading dock following parking for this purpose. If, however, the required loading height is already known beforehand and has been transmitted from the database to the vehicle, using the position determination device 40, a corresponding height adjustment may be performed beforehand. By way of example, the transport vehicle may adjust the loading area to the desired height already upon approach to the corresponding loading station. On the other hand, this may be performed fully automatically without the driver having to interact with the system. It is likewise optionally possible for the corresponding height values to be able to be read or viewed on a corresponding interface that is present.

Another case of application is that of height limits at crossing sections, where it may be necessary for the highest point of the utility vehicle not to be allowed to exceed a maximum height, for example in order to be able to travel freely underneath traffic light systems or similar restrictions. The height measurement may in this case be performed by way of example at the highest point of the vehicle as a reference point. As an alternative, the height measurement may be performed at any other desired point of the frame or of the body, a corresponding recalculation possibly being possible in this case. On the other hand, the vehicle may obtain the required information from the database via the interface 110 and store it locally in the utility vehicle. Using this information, the system may in particular prompt the suspension system, immediately before reaching the corresponding points, to automatically lower the vehicle or the vehicle parts and then, after travelling through, in turn allow a return to the normal state.

As already mentioned, corresponding axles of utility vehicles may also be raised autonomously, since it may be necessary at particular positions to adjust the vertical position of the axles. This information as well, that is to say where necessary, may be retrieved from the attached database.

The positions at which a height adjustment is intended to be performed may be determined for example by way of a global positioning system. As an alternative, it is likewise possible to identify these points using reference points that are provided for example on the roadway or on the buildings and are able to be acquired by a particular sensor system of the vehicle. To this end, for example cameras, laser scanners, radars or other location systems may be provided in the utility vehicle and a corresponding infrastructure (for example specific bar codes or signs) may be provided on buildings or on the roadway. The current position in relation to the reference points may be determined for example using dynamic vehicle sensors, such as for example a tachometer, a rotation rate sensor, a steering angle sensor or other sensors.

The information able to be loaded from the database into the vehicle may be stored in a memory in the utility vehicle together with other information (for example in a navigation system). This information may likewise be combined with corresponding map material so as thereby to facilitate orientation and position determination.

The features of the invention that are disclosed in the description, the claims and the figures may be essential to implementing the invention both individually and in any desired combination.

### THE LIST OF REFERENCE SIGNS IS AS FOLLOWS

40 position determination device
50 height adjustment device
110 interface for receiving data
130 control unit
310, 320, 330 buildings
210, 220, etc. predetermined positions/locations

1-12. (canceled)

13. A system for adjusting a height of at least one part of a utility vehicle at at least one predetermined location, wherein the utility vehicle has a position determination device and a height adjustment device to determine a position of the utility vehicle and to change a height of the at least one part of the utility vehicle above a ground surface, comprising:
an interface to receive data that indicate a target height of the at least one part of the utility vehicle at the predetermined location; and
a control unit that is couple-able to the position determination device and to the height adjustment device, and is configured, based on a determined position, to prompt the height adjustment device of the utility vehicle to adjust the height of the at least one part of the utility vehicle to the target height.

14. The system of claim 13, wherein the interface is configured to receive the data regarding the target height from a remote database, in particular using a wireless connection, and to store values for the target height together with the position of the predetermined location.

15. The system of claim 13, wherein the control unit is configured to determine an instantaneous distance of the utility vehicle to the predetermined location or an expected duration until the utility vehicle reaches the predetermined location or to query this from the position determination device, and to prompt the height adjustment device to adjust the height when the instantaneous distance or the expected duration until arrival at the predetermined location lies below a threshold value.

16. The system of claim 13, wherein the control unit is configured to determine a vertical position of the at least one part of the utility vehicle on the basis of data from the position determination device or to query this from the position determination device.

17. The system of claim 13, wherein the control unit is configured to determine the position in at least one horizontal coordinate on the basis of data from the position determination device or to query this from the position determination device.

18. The system of claim 13, further comprising:
a sensor unit coupled to the control unit and having at least one of the following: a radar, a laser scanner, a wireless transmission device, a mobile radio module, a differential or global positioning system, a camera and a further location system;
wherein the control unit is configured to determine a relative position on the basis of data from the sensor unit.

19. The system of claim 18, wherein the control unit is configured, based on the sensor data from the sensor unit, to acquire a reference point in surroundings of the utility vehicle and to determine a position of the utility vehicle in relation to the reference point.

20. The system of claim 13, wherein the utility vehicle has at least one dynamic vehicle sensor that is configured to determine a speed and/or change of direction of the utility vehicle, and wherein the control unit is configured, based on the sensor data from the at least one dynamic vehicle sensor, to determine at least one change of position in relation to a previously acquired position, so as to allow tracking of a movement path.

21. The system of claim 13, wherein the control unit is configured to prompt the height adjustment without interaction with the driver of the utility vehicle, so that the system is implementable in a self-driving utility vehicle.

22. A utility vehicle, comprising:
a position determination device;
a height adjustment device; and
a system for adjusting a height of at least one part of the utility vehicle at at least one predetermined location, wherein the utility vehicle has a position determination device and a height adjustment device to determine a position of the utility vehicle and to change a height of the at least one part of the utility vehicle above a ground surface, including:
an interface to receive data that indicate a target height of the at least one part of the utility vehicle at the predetermined location; and
a control unit that is couple-able to the position determination device and to the height adjustment device, and is configured, based on a determined position, to prompt the height adjustment device of the utility vehicle to adjust the height of the at least one part of the utility vehicle to the target height.

23. The utility vehicle of claim 22, wherein the at least one part of a utility vehicle is a floor of a vehicle entrance or a characteristic highest elevation of the utility vehicle or a side point having a shortest height or a point of a vehicle axle.

24. A method for adjusting a height of at least one part of a utility vehicle at at least one predetermined location, the method comprising:
receiving data that indicate a target height of the at least one part of the utility vehicle at the predetermined location, wherein the utility vehicle has a position determination device and a height adjustment device that are configured to determine a position of the utility vehicle and to change a height of the at least one part of the utility vehicle above a ground surface;
determining a position of the utility vehicle; and
adjusting a height of the at least one part of the utility vehicle to the received target height.
